(19) United States
(12) Patent Application Publication
(10) Pub. No.: US 2012/0130802 A1
(43) Pub. Date: May 24, 2012

(54) SYSTEMS, METHODS AND APPARATUS TO DESIGN AN ADVERTISING CAMPAIGN

(76) Inventor: Jerome Shimizu, Jersey City, NJ (US)

(21) Appl. No.: 12/950,346

(22) Filed: Nov. 19, 2010

(51) Int. Cl. G06Q 30/00

(52) U.S. Cl. 705/14.44

(57) ABSTRACT

Methods and apparatus are disclosed to tailor an advertising campaign. A disclosed example method involves receiving, by a processor, an indication of user exposure to a first advertisement, selecting, by the processor, a survey prompt based on the indication of user exposure to the advertisement, and sending the survey prompt for presentation in a web-based challenge prompt.

### FIELD OF THE DISCLOSURE

This disclosure relates generally to advertising, and, more particularly, to systems, methods and apparatus to design an advertising campaign.

### BACKGROUND

In recent years, advertisers have cultivated information related to consumers, consumer preferences, consumer buying habits and other characteristic behaviors related to consumers. Some consumer researchers have employed a consumer segmentation system in which every U.S. household is identified as residing in one of sixty-six demographically and behaviorally distinct segments. When a household is identified as associated with one of the sixty-six segments, such households can be expected to include members having similar likes, dislikes, lifestyles, purchasing behaviors and/or media preferences. Advertising campaigns may be designed in a manner that focuses on these demographically and behaviorally distinct segments to advertise products and/or services.

### BRIEF DESCRIPTION OF THE DRAWINGS

FIG. 1 is a schematic illustration of a system to design an advertising campaign.

FIG. 2 is a schematic illustration of an example campaign manager that may be used in the system of FIG. 1.

FIGS. 3, 4, 6 and 7 are flowcharts representative of example processes that may be performed by the example system shown in FIG. 1.

FIG. 5 is a matrix of example creatives and target audience types that may be evaluated by the system of FIG. 1.

FIG. 8 is a schematic illustration of an example processor platform that may perform the processes of FIGS. 3, 4, 6 and 7 to implement any or all of the example systems, methods and apparatus described herein.

### DETAILED DESCRIPTION

Example methods, systems, articles of manufacture and apparatus to design an advertising campaign are disclosed. A disclosed example method involves receiving, by a processor, an indication of user exposure to a first advertisement, selecting, by the processor, a survey prompt based on the indication of user exposure to the advertisement, and sending the survey prompt for presentation in a web-based challenge prompt.

Media measurement companies and/or advertisers attempt to generate and provide information related to the effectiveness of advertising campaigns to enable advertisers, service providers and/or product manufacturers to proceed with an advertising campaign that will result in improved market performance. Any number of brand metrics are typically employed to assess advertising campaign effectiveness, such as, but not limited to brand awareness, product recall and brand favorability. For example, brand awareness is a type of brand metric that identifies a degree of consumer knowledge that a brand of interest exists. Advertisers seek to improve brand awareness because of its influence on purchasing behavior for the product and/or service.

To obtain measurements and/or data related to one or more metrics related to brands for a digital marketing/advertising campaign, one or more surveys may be placed on a web page with an invitation for a consumer to participate. During the course of web browsing activities, a consumer may choose to participate by clicking on a link, or choose to simply ignore the linked survey and review alternate portions of the web page and/or navigate to other web pages. In the event a consumer visits a web page of the publisher, the consumer may be presented with a creative based on the consumer's type (e.g., demographic type, behavioral characteristic, behavioral tendencies, etc.). As used herein, the term “creative” refers to an advertising theme, an advertising point-of-focus and/or a candidate advertisement for analysis. For example, an advertisement associated with a pet food manufacturer may select a creative that includes a picture of a woman walking her dog on a leash. In another example, the pet food manufacturer may select a creative that includes a picture of a cat watching a fish swim in a bowl. Creatives are not limited to pictorial images, but may also include other forms of media including, but not limited to video, audio and/or text.

Advertisers may generate more than one creative for an advertising campaign in an effort to promote their product and/or service. Each of the generated creatives may be a candidate for use in the advertising campaign. In some instances, the advertiser may select more than one creative to use in the campaign, but multiple creatives in advertising campaigns may become cost prohibitive. Whether an advertiser decides upon a single creative or more than one creative for a marketing/advertising campaign, the advertiser must also identify and select an appropriate target audience for the creative(s). Certain target audiences may be more receptive to specific creatives, thereby improving the effectiveness of the advertising/marketing campaign. In some instances, the advertisers may identify a target audience via the Prizm® Segmentation system, in which every U.S. household is identified as residing in one of sixty-six demographically and behaviorally distinct segments. In some examples, the advertiser may prepare a creative for a luxury car and have a reasonable degree of confidence that the target audience should be potential consumers having an affluent lifestyle. However, the advertiser may not appreciate that some mid-level income demographics also respond to the creative in a positive manner. Current analysis methods do not provide an objective manner for the advertiser to decide which creatives to use with which target audiences to obtain the highest (e.g., to optimize) advertisement effectiveness.

Unfortunately, performing copy testing, in which one or more creatives are presented to a test audience (or where a single creative is presented to different test audiences), becomes cost prohibitive and time consuming. In some examples, copy testing includes running a television commercial in a non-national test market and then analyzing sales figures to derive the effectiveness of the television commercial. While such analysis may permit the advertiser to refine and/or otherwise adjust the creative, only a single creative may be employed at one time if feedback is to be deemed relevant to the specific creative and/or a decision to refine the creative. Additionally, the test market may not reveal data with sufficient granularity to identify which target audiences found the advertisement good, bad, effective, and/or any other brand metric to be derived from the advertisement exposure. Furthermore, in the event the advertiser wants to analyze a separate creative, then a subsequent test audience must be exposed to the separate (alternative) creative in a series manner, or a separate test audience market must be employed. In the event that the advertiser has two candidate creatives (e.g., creative A and creative B) and two candidate target demographics (e.g., target 1 and target 2), then four testable combinations exist. That is, group A1, A2, B1 and B2, all of which may be expensive to test. As a result, some advertisers proceed with their subjective best judgment in view of the cost prohibitive task of copy testing all four candidate combinations.

To illustrate the value of testing an advertisement prior to running a campaign (e.g., a national campaign directed to a target audience with a specific creative), assume a survey is conducted in which 50% of the respondents that have not seen an advertisement for Coke Zero® already know the product exists. In other words, the survey of respondents who have not seen the new creative for Coke Zero® reflects a brand awareness of 50%. After running and/or otherwise exposing an audience to the new creative for Coke Zero®, respondents that have seen the creative reflect a brand awareness of 70%. As such, an advertiser can appreciate that the new creative produces a 20 point increase in brand awareness. However, the 20 point increase in brand awareness cannot be considered particularly good or bad if there are no alternate combinations of creatives and target audiences for the campaign. In other words, another candidate creative might produce a corresponding increase in brand awareness of 35 points, while yet another candidate creative might only produce a corresponding increase in brand awareness of 15 points. To allow the advertiser to reveal and appreciate these relative differences, a time-linear series of copy test procedures must be executed, which introduces substantial costs to the campaign design efforts.

When facilitating an on-line digital survey, advertisers deem a click through rate (CTR) of 0.5% to be an acceptable measure of success for an advertisement or survey on a web page. In other words, for every 10,000 viewers of a web page, if only 500 of those viewers click on the advertisement or survey, then the advertisement or survey is deemed to be effective. However, the advertiser may be required to pay a finite amount of money each time the link for the survey is presented on a web page, regardless of whether the link is clicked or noticed by the consumer. Such a high incidence of advertisements presented, yet neither noticed nor engaged, is sometimes referred to as inventory waste.

At least one additional problem realized when employing traditional digital survey techniques relates to an inability to create stratified control groups. Such a lack of proper methodological control degrades a confidence value of any data collected by way of on-line digital survey techniques. Additionally, because of the relatively low CTR values associated with traditional on-line digital survey techniques, a correspondingly low number of target and creative combinations may be tested with consumers before the campaign begins. In other words, to gain enough feedback data on a target and creative combination (e.g., a creative showing a woman walking her dog directed to a target audience of women 18-35 earning more than $100 k), thousands of valid survey responses and hundreds of thousands of impressions may be required to achieve a proper statistical significance.

The methods and apparatus described herein facilitate rapid testing of multiple creatives, each directed to a number of selected target audiences. As described below, creatives may be tested in a more rapid and cost effective manner than possible with the linear approaches employed by traditional copy testing. In the event an advertiser wishes to test several creatives simultaneously, the methods and apparatus described herein facilitate such parallel testing of creatives for any number of test audiences that realize a CTR substantially greater than 0.5%.

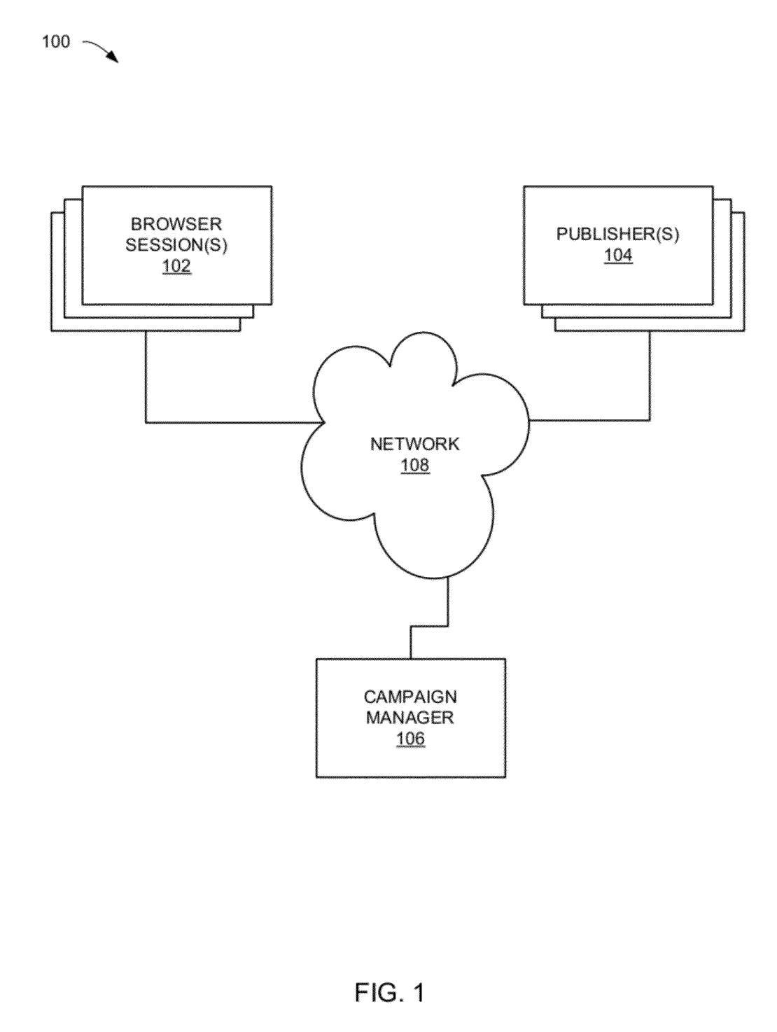

FIG. 1 is a schematic illustration of a system 100 to design an advertising campaign. In the illustrated example of FIG. 1, the system 100 includes a number of browser sessions 102, a number of publishers 104, a campaign manager 106, and a network 108 to allow the browser sessions 102, publishers 104 and campaign manager 106 to communicate. The example browser sessions 102 may include computing devices connected to the example network 108, such as an intranet and/or the Internet. Browser sessions 102 may include instances of user web browsing with a browser program such as, but not limited to Firefox®, Internet Explorer®, Chrome® or Safari®. The example browser sessions 102 communicatively connect to content of the example network 108, such as the one or more publishers 104 that maintain web pages of network accessible information. Web pages are typically reached by the example browser sessions 102 by way of browser navigation to a network address, such as an IPv4 (e.g., www.yahoo.com), IPv6 or other network accessible protocol. On-line content provided by publishers, such as the publishers 104 of FIG. 1, include, but is not limited to web pages, video services, audio services, audio/video streaming, etc. An example on-line audio/video service includes Hulu®, in which on-line visitors may watch movies, television programs and/or other audio/video content. Another on-line video service includes YouTube®, while example audio services include Pandora® and Slacker® radio, which provide music streaming services.

In operation, the example campaign manager 106 may be a marketing entity and/or other organization chartered with the responsibility to assess candidate creatives for use in an advertising/marketing campaign. As described above, an advertiser may have any number of candidate creatives to, for example, promote a product and/or service. However, some creatives may evoke a better response when directed to a particular target audience, such as a particular demographic identified by the Prizm® Segmentation system. In the event that a campaign manager selects a creative for the marketing campaign that does not evoke a satisfactory response for the manufacturer and/or service provider, the entity and/or organization chartered with managing the campaign may not enjoy future business opportunities. Copy testing one or more creatives is typically an expensive process that requires consumer exposure on a limited scale to ascertain the effectiveness of a creative or creatives with target audience(s). In some instances, the marketing entity acquires as much copy testing feedback as possible, but must still resort to selecting from a number of candidate creatives based on a gut-feel, past industry experience and/or other subjective manners.

The methods and apparatus described herein facilitate assessment of a number of creatives relative to a number of target audience groups in a manner that increases exposure response while reducing copy testing expense and reducing inventory waste. As described in further detail below, the example system 100 exposes users to the candidate creative(s) and then presents the users with a survey tailored to the exposed creative(s) in a manner that ensures a response. Unlike web-based survey response requests, in which the web visitor may optionally participate or choose to not participate in a web survey (e.g., one or more radio button answers to a question), the methods and apparatus described herein tailor survey questions based on whether the user was exposed to the candidate creative(s) or not. Additionally, the tailored survey question(s) are presented to the target audience members in a manner that requires a response if that target audience member wishes to proceed to one or more subsequent portions of the web page and/or other network information.

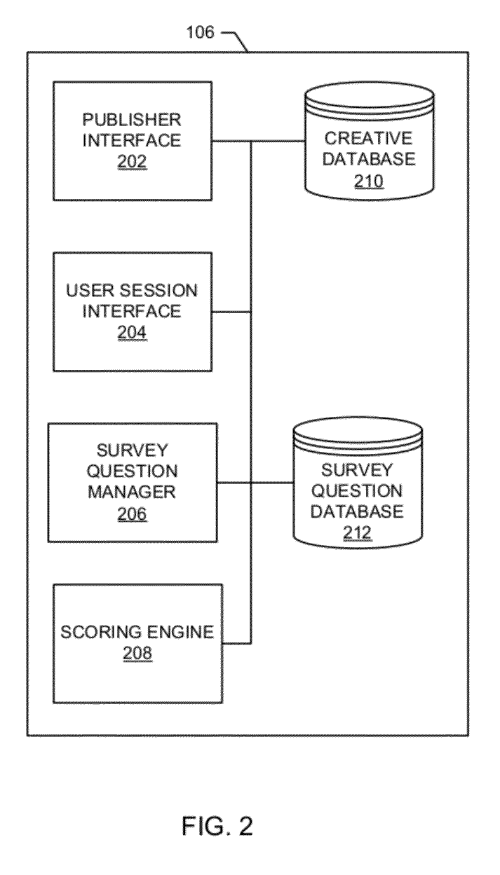

FIG. 2 is a schematic illustration of the example campaign manager 106 of FIG. 1. In the illustrated example of FIG. 2, the campaign manager 106 includes a publisher interface 202, a user session interface 204, a survey question manager 206, a scoring engine 208, a creative database 210, and a survey question database 212. The example publisher interface 202 communicatively interfaces with the one or more publishers 104 and the example user session interface 204 communicatively interfaces with the one or more browser sessions 102. In operation, the example publisher interface 202 provides a participating publisher(s) 104 with one or more candidate creative(s) to be presented to visitors to the publisher site(s). The one or more candidate creative(s) may be stored in the example creative database 210.

In response to a user visiting the publisher 104, the publisher presents the user with one or more creatives, such as one or more creatives previously provided to the publisher 104 from the example creative database 210. As described in further detail below, creatives presented may be based on the target type (e.g., Young Digerati, a behavioral characteristic, a demographic characteristic, etc.). The publisher 104 also embeds a tag in the creative so that, when the browser session 102 renders the creative(s), information is redirected back to the example user session interface 204 of the campaign manager 106. The tag may include an object embedded in a web page that is typically not visible to a viewer of the web page, but allows the publisher or other entity to determine that the user has viewed the page. The example tag is sometimes referred to as a 1×1 gif, a tracking pixel, or a page tag. Information sent back to the example user session interface 204 may include, but is not limited to a target type to which the user belongs (e.g., one of the 66 Prizm® types—“Young Digerati”), and information identifying to which creative the user was exposed. Prior to presenting one or more users associated with one or more target audience groups with survey questions, the example campaign manager 106 exposes users in browser sessions 102 with the candidate creatives.

In response to a user visiting the example publisher 104 at a time after being exposed to one or more creatives, the example publisher interface 202 receives an indication of the type of web page that the user happens to be visiting. For example, some web pages include web-based challenges such as one or more techniques to verify that the web visitor is a human rather than a bot, such as a bot that scours the Internet for web page content to be consolidated and stored (e.g., stored by a search engine to facilitate user queries). An example manner of distinguishing between bots and humans includes a challenge-response test, sometimes referred to as CAPTCHA (Completely Automated Public Turing test to tell Computers and Humans Apart—hereinafter referred to herein as “Captcha”). In typical applications, the Captcha challenge displays a series of letters and/or numbers in an augmented font in a manner to prohibit non-human recognition. For example, the series of letters and/or numbers may be warped, include auxiliary lines, mix capital and lower-case, crowd characters together, and/or other manners to inhibit machine readability.

In other examples, a Captcha challenge may be employed to verify that a viewer is engaged with presented content. For example, if a viewer initiates streaming content, such as streaming music (e.g., Pandora®) or streaming video (e.g.,) Hulu®, a Captcha challenge may require one or more responses before the viewer is permitted to receive additional content. For example, on-line video services, such as Hulu®, present the viewer with a commercial or advertisement at various times during the media content presentation (e.g., a television show streamed on-line). The methods, apparatus, systems and articles of manufacture described herein may employ a video Captcha at the various advertisement times to cause the viewer to respond before continuing to present the media content. As described in further detail below, Captcha challenges, video Captcha challenges or other challenges may be tailored to present survey question(s) related to a campaign of one or more creative(s).

In the event that the user of the browser session 102 is visiting a site of the example publisher 104 that includes a Captcha challenge, the example survey question manager 206 determines which creative(s) the user has and has not been exposed to and/or otherwise receives an indication of user exposure to the creative(s). In some examples, the campaign manager 106 presents the user at the browser session 102 with a survey question tailored to one or more creatives that the user has seen. In that case, the example survey question manager 206 obtains one or more survey questions from the example survey database 212. For example, in the event that the user was exposed to a creative related to an energy drink, the survey question may be “Do you prefer Rockstar, Red Bull or Monster energy drinks?” In other examples, the campaign manager 106 presents the user at the browser session 102 with a survey question tailored to one or more creatives to which the user was not exposed. For example, the same survey question may be presented to the user that has been exposed to alternative creatives in an effort to establish a control group, thereby improving the statistical validity of statistical conclusions derived from the collected survey answers.

After user exposure to one or more creatives, and/or exposure to creatives unassociated with the campaign (e.g., for purposes of control group data collection), the example scoring engine 208 identifies which creative/target pair is likely to yield the best results. For example, if a marketing analyst is chartered with the responsibility to identify whether creative A or creative B works better with target group 1 or target group 2, then the example scoring engine 208 may rank A1, A2, B1 and B2 in a manner that allows selection of the highest scoring creative/target pair. At least one benefit of the methods, apparatus, systems and articles of manufacture described herein is an ability to identify whether a candidate creative is particularly and/or relatively more effective over other candidate creatives being considered for a marketing campaign. Rather than determining an indication of the effectiveness for a creative for a general audience, the methods, apparatus, systems and articles of manufacture described herein allow one or more target audience groups/types to be analyzed in a manner that illustrates a relative effectiveness for both candidate creatives and corresponding target audience groups/types.

While an example manner of implementing the campaign manager 106 of FIG. 1 has been illustrated in FIG. 2, one or more of the elements, processes and/or devices illustrated in FIG. 2 may be combined, divided, re-arranged, omitted, eliminated and/or implemented in any other way. Further, the example campaign manager 106, the example publisher interface 202, the example user session interface 204, the example survey question manager 206, the example scoring engine 208, the example creative database 210 and/or the example survey database 212 of FIG. 2 may be implemented by hardware, software, firmware and/or any combination of hardware, software and/or firmware. Thus, for example, any of the example campaign manager 106, the example publisher interface 202, the example user session interface 204, the example survey question manager 206, the example scoring engine 208, the example creative database 210 and/or the example survey database 212 could be implemented by one or more circuit(s), programmable processsor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example campaign manager 106, the example publisher interface 202, the example user session interface 204, the example survey question manager 206, the example scoring engine 208, the example creative database 210 and/or the example survey database 212 are hereby expressly defined to include a computer readable medium such as a memory, DVD, CD, etc. storing the software and/or firmware. Further still, the example campaign manager 106 of FIG. 1 may include one or more elements, processes and/or devices in addition to, or instead of, those illustrated in FIG. 2, and/or may include more than one of any or all of the illustrated elements, processes and devices.

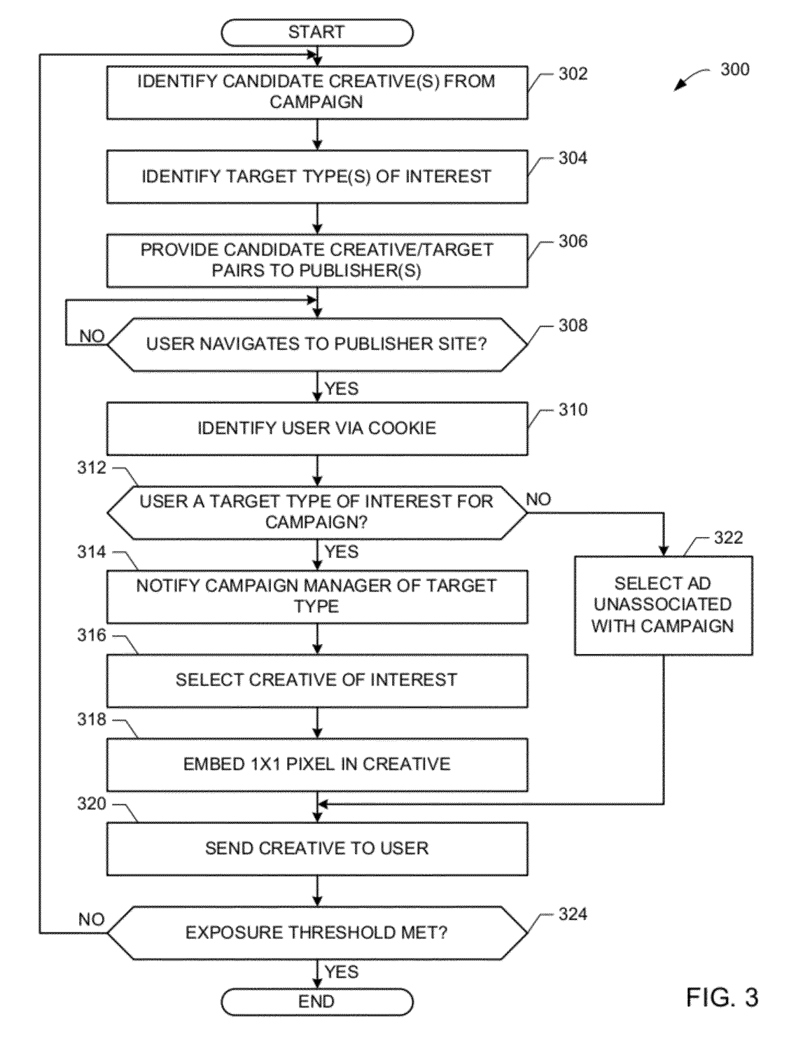

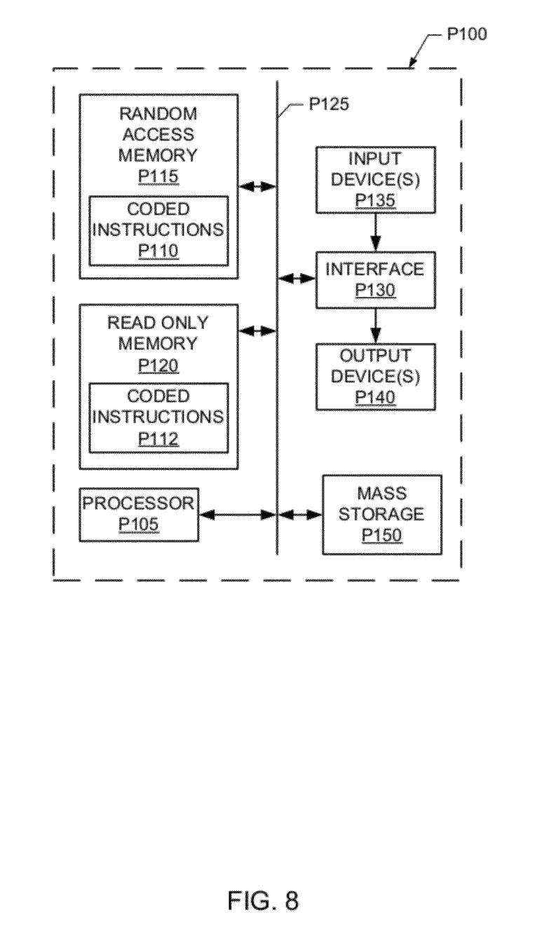

Flowcharts representative of example processes for implementing the campaign manager 106 of FIGS. 1 and 2 are shown in FIGS. 3, 4, 6 and 7. In these examples, the processes may be implemented using machine readable instructions that comprise programs for execution by a processor such as the processor P105 shown in the example computer P100 discussed below in connection with FIG. 8. The programs may be embodied in software stored on a computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example programs are described with reference to the flowcharts illustrated in FIGS. 3, 4, 6 and 7, many other methods of implementing the example campaign manager 106 may alternatively be used. For example, the order of execution of the blocks may be changed, and/or some of the blocks described may be changed, eliminated, or combined.

As mentioned above, the example processes of FIGS. 3, 4, 6 and 7 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3, 4, 6 and 7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The example process 300 of FIG. 3 begins at block 302 where the example campaign manager 106 identifies one or more candidate creatives from a campaign to test. For example, a campaign related to pet food may include an image-based creative of a woman walking a mid-size dog, and another image-based creative of a cat watching a fish swim in a bowl. Additionally, the example campaign may be directed to three candidate target groups, such as a group of premium pet food buyers, a group of women 18-35 with a household income greater than $100 k, and a group from Prizm® group #4 (i.e., Young Digerati). The example campaign manager 106 identifies the candidate target types or groups (block 304), which may be based on one or more Prizm® group(s), and/or any other characteristic of group members. Candidate target types may include behavioral and/or demographic characteristics such as, but not limited to, portions of a population that tend to visit web sites using Captcha challenge questions (e.g., portions of a population that frequent blogging content). In other examples, target type(s) of interest (block 304) may be identified from one or more panelist groups, such as demographically and/or behaviorally generated panelist groups cultivated by Nielsen °. Behaviorally generated panelist groups may be based on, for example, purchasing habits of one or more consumers. While the expense of an exhaustive traditional copy test for each candidate creative for each candidate target group would result in six separate tests, the example methods and apparatus described herein allow all six groups to be tested for substantially less cost and receive a greater response rate. The example publisher interface 202 provides each of the candidate creatives to the example publisher(s) 104 that choose to participate in the campaign study (block 306). The example publisher(s) 104 may store the one or more candidate creatives in a memory and/or database to be retrieved in response to user visit(s). Additionally, the example publisher(s) 104 may store the one or more candidate target group types so that, in response to identifying a specific user associated with the candidate target group, one or more candidate creatives may be presented, as described in further detail below. As described above, the example publisher(s) 104 may include one or more entities having a web/Internet presence, such as merchants, service providers, corporations, government entities and/or third party portals, such as Facebook®.

If a user from one or more browser session(s) 102 navigates to the publisher 104 (block 308), the publisher 104 identifies the user via a cookie (block 310). In some examples, the publisher 104 cultivates information related to users that visit and/or clickstream information. The clickstream information may, over time, reveal information indicative of the type of visitor (e.g., a target type). Such target type information may be stored in cookie data that, when received by the example publisher 104, allows the publisher 104 to target the visitor with relevant dynamic content. As described above, if the target type of interest (block 304) is related to audience members (viewers) having a greater tendency or propensity to visit web sites having Captcha challenge(s), then the example publisher 104 may provide corresponding web visitors with cookies containing identifiers to indicate such tendencies. During subsequent visits to the publisher's content (e.g., web page(s), video stream(s), etc.), the cookie may identify the visitor as a type that tends to illustrate heavy Captcha participation, and one or more specific creative(s) may be presented to that visitor based on those observed behavioral indicators. If the visitor is identified as a target type of interest for the campaign (block 312), the example publisher 104 forwards a notification message to the example publisher interface 202 of the campaign manager 106 (block 314). The example user session interface 204 selects a corresponding candidate creative of interest, such as an identifying name or serial number of the creative to be presented by the publisher 104 (block 316). As described above, because the example publisher 104 has already stored the candidate creatives (e.g., images, videos, audio, etc.), the example user session interface 204 only needs to communicate which one via the name or serial number (block 316).

In some examples, the campaign manager 106 choreographs copy testing for any number of participating publishers 104. Accordingly, when the example user session interface 204 receives an indication that a target group of interest is browsing the publisher site, the campaign manager 106 can track how many and/or which creative impressions occur to the corresponding target groups. For example, the user session interface 204 may count the number of instances where creatives/targets occur before a threshold number of exposures (e.g., 3000 exposures of creative/target A1, 3000 exposures of creative/target A2, 3000 exposures of creative/target B1, etc.). If a particular creative/target combination has a sufficient number of exposures, or not enough exposures, the example user session interface 204 can direct the publisher 104 to present a specific creative to the corresponding target (block 316). In other examples, the user session interface 204 directs the publisher 104 to present a creative to the target that is unassociated with the campaign to satisfy proper statistical control efforts.

The example publisher 104 may embed a tag (e.g., a 1×1 pixel gif) in the creative (block 318). The tag may include, but is not limited to, information related to which target type was exposed and/or which creative was exposed. When the example user at the browser session 102 retrieves and/or otherwise receives the creative from the publisher (block 320), the embedded tag causes a redirect of information to one or more destinations that contain the aforementioned information related to which target type was exposed and/or which creative was exposed. In some examples, the tag redirects to the example campaign manager 106 to confirm exposure. In other examples, the tag redirects to a third party entity, such as Facebook®, to communicate that a specific user was exposed to a specific creative, as described in further detail below.

Returning briefly to block 312, in the event that the user is not within the target type of interest, then the example publisher 104 proceeds without guidance by the example campaign manager 106 and presents the web visitor with an advertisement pursuant to its own directives (block 322). If the example campaign manager 106 has not reached an exposure threshold for creative/target pairs (block 324), then control returns to block 302. Otherwise, the example program 300 of FIG. 3 ends when a threshold number of creative/target pairs are exposed (block 324).

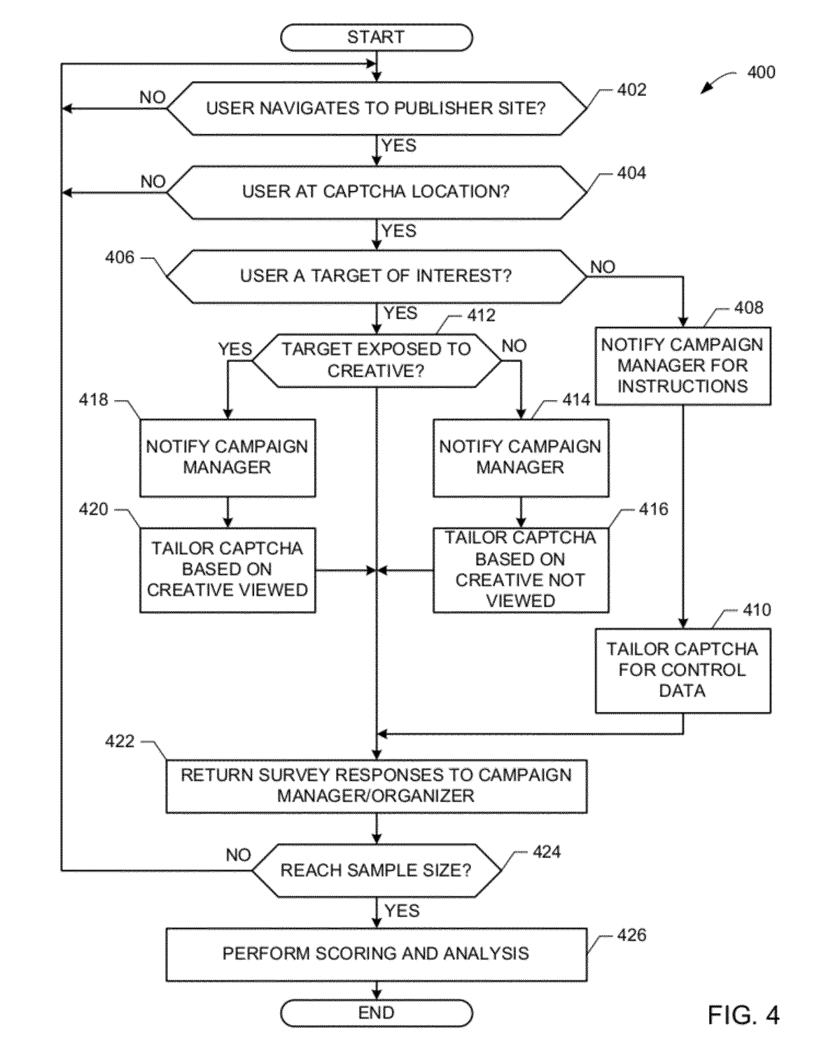

The example process 400 of FIG. 4 begins at block 402 where the example publisher 104 determines whether a user from the browser session 102 navigates to the publisher's site. If not, the publisher 104 continues to wait for a user visit, otherwise the example publisher 104 determines whether the visiting user is at a page having a Captcha (block 404). In other examples, the publisher 104 determines whether the visiting user is at a page having a video Captcha and/or any other type of web site of interest (block 404). If the user is not visiting at a Captcha page (block 404), control returns to block 402, otherwise the example publisher 104 determines if the user is within the target group of interest (block 406). If not, then the example user session interface 204 receives an indication from the publisher 104 requesting instructions (block 408). The example user survey question manager 206 provides the publisher 104 with instructions (block 410), such as instructions to tailor the Captcha survey based on a creative not previously exposed to the user, or directs the publisher 104 to proceed as it would absent the campaign. For example, the survey question manager 206 may not require further control group survey responses and instruct the publisher 104 to forego any survey questions and, instead, prompt a normal Captcha to the user.

If the user is within one of the target groups of interest (block 406) (e.g., as determined by a cookie retrieved from the user browser session 102 by the publisher 104), the publisher determines whether the target user has been exposed to the creative of interest (block 412). Information regarding whether the user was exposed to the creative may be saved/stored by the publisher 104 in a memory or a database, or may be revealed through cookie data. In other examples, the publisher 104 may request exposure confirmation from the campaign manager 106, such as information saved by the campaign manager 106 when the tag redirect occurred during a prior exposure, as described above. If the user was not exposed to the creative of interest (block 412), but is still a target type of interest (block 406), then the publisher 104 notifies the campaign manager 106 for instructions on how to proceed (block 414). The campaign manager tailors the Captcha based on a creative to which the user was not exposed (block 416) to obtain survey responses for a control group. However, in the event that the campaign manager 106 has received a sufficient number of control group survey responses to calculate statistically significant conclusions, the example survey question manager 206 may choose to instruct the publisher 104 to invoke the Captcha in a normal manner (e.g., produce a challenge question without reference to the campaign). In other examples, the Captcha (and/or video Captcha) tailors the challenge to allow the viewer to provide an indication of the type(s) of advertising content they prefer to receive in the future (block 416).

Returning to block 412, in the event that the user was exposed to the creative of interest, then the publisher 104 notifies the campaign manager 106 for instructions on how to proceed (block 418). Depending on which creative of interest to which the user was exposed, the example survey question manager 206 tailors the Captcha (block 420). For example, if the creative of interest relates to the aforementioned energy drink, the tailored Captcha survey question may be “Do you prefer Rockstar, Red Bull or Monster energy drinks?” On the other hand, if the creative of interest relates to a different campaign related to pet food, the tailored Captcha survey question may be “What is the best pet food? Purina, Fancy Feast, or Pro Plan?” In still other examples, and as described above, the Captcha (and/or video Captcha) tailors the challenge (e.g., challenge question(s)) in a manner that allows the viewer to provide an indication of the type(s) of advertising content they prefer to receive in the future. In effect, the users at websites that ordinarily employ a Captcha technique to distinguish between humans and non-humans (e.g., bots), must answer the challenge before being allowed to proceed. Typically, Captcha challenges occur at sites that allow user blog entries and/or comments to occur, thereby preventing and/or minimizing unwanted solicitation on the blog and/or message board. Unlike a pop-up survey or a survey section of a web page that may be present on the user's computer, which are voluntary and may be ignored and/or otherwise skipped, the Captcha challenge question must be answered before the user is allowed to proceed. Accordingly, the response rate is substantially higher when using tailored survey questions with Captcha challenge questions as compared to on-line voluntary survey questions.

Survey responses are returned to and/or otherwise received by the example survey question manager 206 (block 422), and the example campaign manager 106 determines whether a threshold sample size of the campaign copy test is reached (block 424). If not, control returns to block 402, otherwise the example scoring engine 208 performs scoring and analysis of the creative/target pairs (block 426).

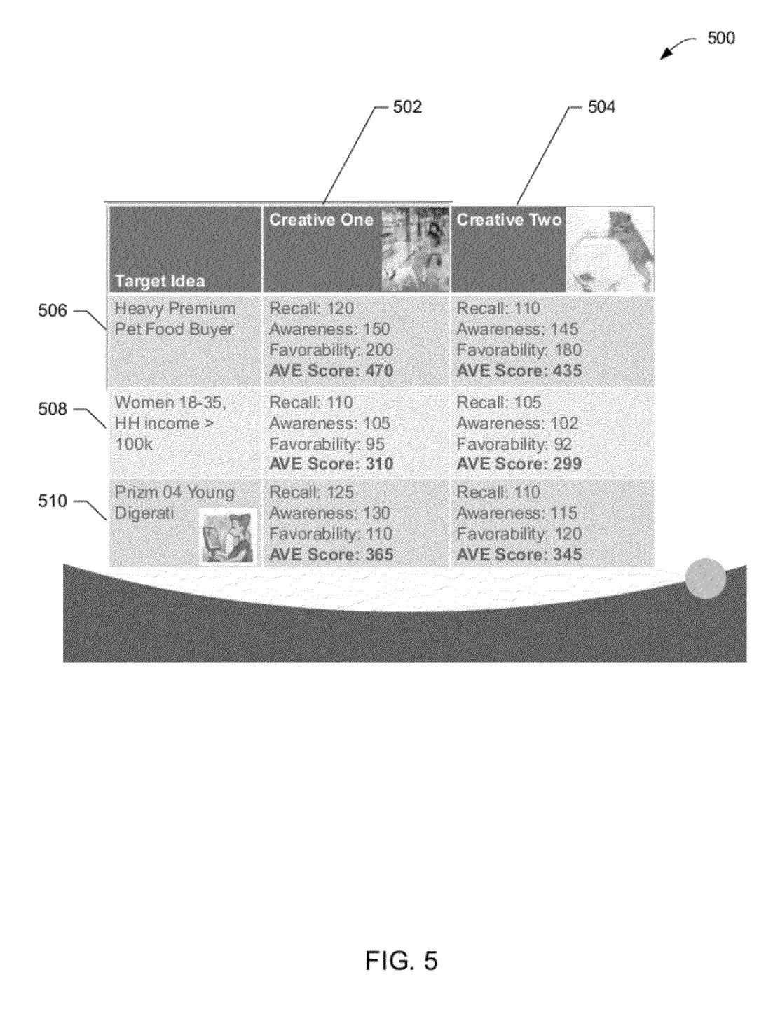

FIG. 5 is a matrix 500 of example creatives and target audience types that may be analyzed by the example methods, apparatus, articles of manufacture and systems described herein. In the illustrated example of FIG. 5, the matrix 500 includes a first candidate creative 502, a second candidate creative 504, a first candidate target audience 506, a second candidate target audience 508 and a third candidate target audience 510. Each candidate creative and candidate target audience type intersect at one cell of the example matrix 500 to reveal analysis results of the candidate creative/target pair. The example scoring engine 208 receives all survey responses from the Captcha challenges for each candidate creative/target pair, and receives all survey responses from the Captcha challenges associated with users that have not seen one or more of the creatives associated with the campaign for control purposes. Any manner of statistical analysis may be employed by the example scoring engine 208 to score one or more marketing effectiveness metrics of the candidate creative when presented to one or more candidate target audience types. As described above, any number of brand metrics may be employed to assess advertising campaign effectiveness such as, but not limited to brand awareness, product recall and brand favorability. The one or more survey questions may be designed to reveal an indication of such brand metrics, which are used by the example scoring engine 208 to create one or more values associated with the brand metrics. In the illustrated example of FIG. 5, the scoring engine 208 has calculated a recall value of 120, an awareness value of 150 and a favorability score of 200 for the first creative 502 when exposed to a target audience type associated with heavy premium pet food buyers 506. Additionally, the example scoring engine 208 has calculated a sum value of the metrics of interest, which is higher than that of any other intersecting cell of the example matrix 500.

While the example methods, apparatus, systems and articles of manufacture described above included a focus on web pages that include one or more Captcha challenge questions, the examples are not limited thereto. In some examples, the campaign manager 106 may communicate with one or more third party portals that employ one or more advertising components. Third party portals may include, but are not limited to Facebook®, Twitter®, Foursquare®, Gowalla®, Yelp®, etc.

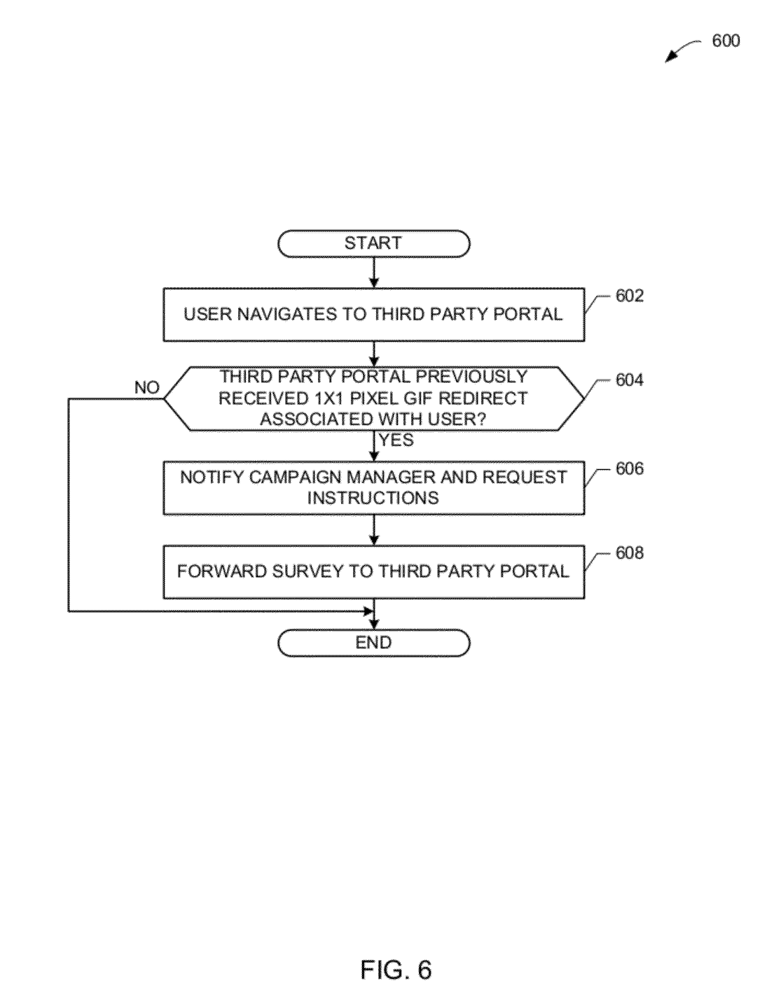

The example process 600 of FIG. 6 begins at block 602 where a cooperating third party portal, such as Facebook®, receives an indication that a user navigates to a display of the third party portal. The third party portal may include a status screen associated with a user, such as a thread of status updates, messages, and/or photos associated with portal friends of the visiting user. While the following examples of the third party portal will refer to Facebook®, the examples are presented for purposes of discussion rather than limitation. The third party portal determines whether it has previously received a tag or a 1×1 pixel gif associated with the user (block 604) and, if not, the example process 600 ends, thereby allowing the third party portal to proceed as it would without cooperation with the example campaign manager 106. On the other hand, if the third party portal determines that it has previously received a tag or a 1×1 pixel gif associated with the user (block 604), then the third party portal notifies the campaign manager and requests instructions (block 606). For example, the third party portal may have been a recipient of the tag redirect when the example publisher 104 embedded it in the creative (block 318), as described above in connection with FIG. 3.

The example user session interface 204 receives the notification from the third party portal (block 606), which causes the survey question manager 206 to retrieve one or more survey questions from the survey question database 212 and forwards such questions to the third party portal for presentation to the user (block 608). The survey questions may be placed by the third party portal anywhere on the portal display, such as in a margin of the display that invites the user to select answers to the survey question(s). However, as described above, presenting the user with a voluntary opportunity to answer the survey question(s) may result in a low response rate.

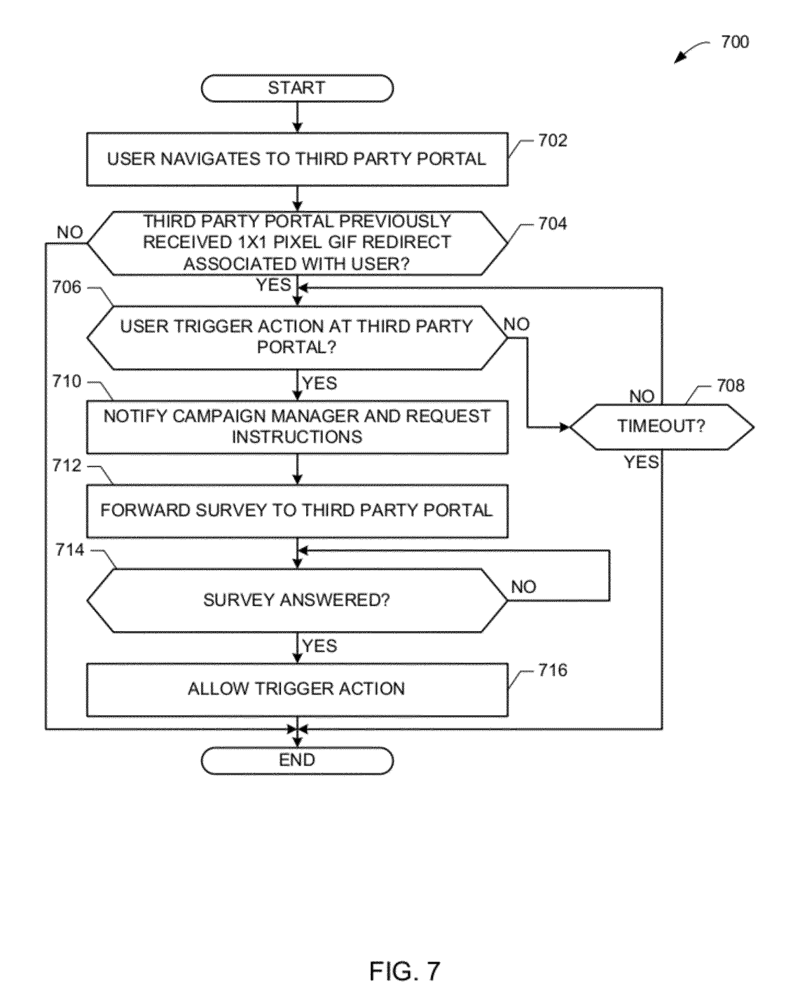

The example process 700 of FIG. 7 begins at block 702 where a cooperating third party portal, such as Facebook®, receives an indication that a user navigates to a display of the third party portal. The third party portal determines whether it has previously received a tag or a 1×1 pixel gif associated with the user (block 704) and, if not, the example process 700 ends, thereby allowing the third party portal to proceed as it would without cooperation with the example campaign manager 106. On the other hand, if the third party portal determines that it has previously received a tag or a 1×1 pixel gif associated with the user (block 704), then the third party portal determines whether the user of the third party portal is interacting with one or more trigger actions of the portal display (block 706). The trigger actions may include, but are not limited to updating a status (e.g., a Facebook® status update, writing a message to another portal participant (e.g., a Facebook® friend), or any other user trigger input to the third party portal display.

In the event that the user/visitor of the third party portal does not trigger one or more actions (block 706), the example third party portal determines whether a timeout period has elapsed (block 708). If not, then the third party portal continues to wait. In some examples, the user/visitor of the third party portal browses status information, but chooses not to interact with the display of the third party portal. If the timeout period elapses (block 708), then the example program 700 of FIG. 7 ends and the third party portal operates without participation from the example campaign manager 106. On the other hand, in response to a trigger action at the display of the third party portal (block 706), the example campaign manager 106 is notified with a message identifying the user/visitor and requesting survey instructions (block 710). As described above, the third party portal may have been a recipient of the tag redirect when the example publisher 104 embedded it in the creative (block 318), as described above in connection with FIG. 3.

The example user session interface 204 receives the notification from the third party portal (block 710), which causes the survey question manager 206 to retrieve one or more survey questions from the survey question database 212 and forwards such questions to the third party portal for presentation to the user (block 712). The third party portal uses the received survey questions to present a pop-up and/or Captcha to the user and, when answered by the user (block 714), the third party portal allows the trigger action to continue (block 716). For example, if the user attempted to update their status information by entering characters in a field of the display of the third party portal (e.g., “Walking my dog to the park . . . what a sunny day!”), then the user is required to answer the survey question(s) before the status information is updated on the display of the third party portal.

FIG. 8 is a block diagram of an example computer P100 capable of executing instructions implementing the processes of FIGS. 3, 4, 6 and 7 and the campaign manager 106 of FIGS. 1 and 2. The computer P100 can be, for example, a server, a personal computer, a mobile phone (e.g., a cell phone). a personal digital assistant (PDA), an Internet appliance, or any other type of computing device.

The system P100 of the instant example includes a processor P105. For example, the processor P105 can be implemented by one or more Intel® microprocessors from the Pentium® family, the Itanium® family or the XScale® family. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller (not shown).

The computer P100 also includes an interface circuit P130. The interface circuit P130 may be implemented by any type of interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, a cathode ray tube display (CRT), and/or a printer). The interface circuit P130, thus, typically includes a graphics driver card.

The interface circuit P130 also includes a communication device (e.g., the example publisher interface 202, the example user session interface 204) such as a modem or network interface card to facilitate exchange of data with external computers via a network (e.g., an Ethernet connection, a digital subscriber line (DSL), a telephone line, coaxial cable, a cellular telephone system, etc.).

The computer P100 also includes one or more mass storage devices P150 for storing software and data. Examples of such mass storage devices P150 include floppy disk drives, hard drive disks, compact disk drives and digital versatile disk (DVD) drives. The mass storage device P150 may implement the example creative database 210 and/or the example survey question database 212.

Coded instructions P112 implementing the processes of FIGS. 3, 4, 6 and 7 may be stored in the mass storage device P150, in the volatile memory P115, in the non-volatile memory P120, and/or on a removable storage medium such as a CD or DVD.

From the foregoing, it will be appreciated that the above disclosed methods, systems, apparatus and articles of manufacture allow one or more creatives to be tested with one or more target audience groups in a manner that produces a greater response rate to survey questions than traditional techniques.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to design a survey, comprising:
receiving, by a processor, an indication of user exposure to a first advertisement;
selecting, by the processor, a survey prompt based on the indication of user exposure to the first advertisement; and
sending the survey prompt for presentation in a web-based challenge prompt.

2. A method as described in claim 1, further comprising receiving an indication of a web-based challenge prompt.

3. A method as described in claim 1, wherein the indication of user exposure comprises receipt of at least one of an identifier of the first advertisement or an identifier of the user.

4. A method as described in claim 1, wherein the indication of user exposure comprises at least one of a tag or a 1×1 pixel gif.

5. A method as described in claim 1, wherein the indication of user exposure is received from a browser.

6. A method as described in claim 1, wherein the indication of user exposure is received from a publisher.

7. A method as described in claim 1, wherein the indication of the web-based challenge prompt comprises a completely automated public turing test to tell computers and humans apart (CAPTCHA).

8. A method as described in claim 7, wherein the selected survey prompt is used as a challenge question for the CAPTCHA.

9. A method as described in claim 7, wherein the CAPTCHA is prompted in at least one of a video-based web service, an audio-based web service or a text-based web service.

10. A method as described in claim 1, further comprising receiving answers from the survey prompt from a first set of audience members and a second set of audience members to identify whether the first advertisement is more effective for the first set of audience members or the second set of audience members.

11. A method as described in claim 10, further comprising receiving answers from the survey prompt from the first set of audience members and the second set of audience members to identify whether a second advertisement is more effective for the first set of audience members or the second set of audience members.

12. A method as described in claim 1, wherein the web-based challenge prompt comprises a status update change request of a social network portal.

13. A method as described in claim 12, further comprising allowing the status update change request after a response is received from the survey prompt.

14. A method as described in claim 1, further comprising selecting the first advertisement for presentation to the user based on a user type.

15. A method as described in claim 14, wherein the user type comprises at least one of a demographic characteristic or a behavioral characteristic.

16. An apparatus to design a survey, comprising:
a publisher interface to receive an indication of user exposure to an advertisement and to receive an indication of a web-based challenge prompt;
a survey question manager to select a survey prompt based on the indication of user exposure to the advertisement; and
a user session interface to send the survey prompt for presentation in the web-based challenge prompt.

17. An apparatus as described in claim 16, wherein the publisher interface receives a 1×1 pixel gif as the indication of user exposure.

18. An apparatus as described in claim 16, wherein the publisher interface receives the indication of user exposure from a browser.

19. An apparatus as described in claim 16, wherein the web-based challenge prompt comprises a completely automated public turing test to tell computers and humans apart (CAPTCHA).

20. An apparatus as described in claim 19, wherein the user session interface sends the survey prompt to the CAPTCHA for presentation in a browser.

21. A tangible machine accessible medium having instructions stored thereon that, when executed, cause a machine to:
receive an indication of user exposure to an advertisement;
select a survey prompt based on the indication of user exposure to the advertisement; and
send the survey prompt for presentation in a web-based challenge prompt.

22. A tangible machine accessible medium as described in claim 21 having instructions stored thereon that, when executed, cause a machine to receive an indication of a web-based challenge prompt.

23. A tangible machine accessible medium as described in claim 21 having instructions stored thereon that, when executed, cause a machine to receive the indication of user exposure via at least one of a tag or a 1×1 pixel gif.

24. A tangible machine accessible medium as described in claim 21 having instructions stored thereon that, when executed, cause a machine to receive the indication of user exposure from at least one of a browser or a publisher.

25. A tangible machine accessible medium as described in claim 21 having instructions stored thereon that, when executed, cause a machine to respond to a completely automated public turing test to tell computers and humans apart (CAPTCHA).

26. A tangible machine accessible medium as described in claim 25 having instructions stored thereon that, when executed, cause a machine to select the survey prompt as a challenge question for the CAPTCHA.

27. A tangible machine accessible medium as described in claim 25 having instructions stored thereon that, when executed, cause a machine to receive answers from the survey prompt from a first set of audience members and a second set of audience members to identify whether the advertisement is more effective for the first set of audience members or the second set of audience members.
